(19) United States
(12) Patent Application Publication
(10) Pub. No.: US 2014/0118439 A1
(43) Pub. Date: May 1, 2014

(54) INKJET PRINTER

(71) Applicant: Hiroaki Kambe, Chiba (JP)

(72) Inventor: Hiroaki Kambe, Chiba (JP)

(73) Assignee: SEIKO I INFOTECH INC., Chiba (JP)

(21) Appl. No.: 14/005,644

(22) PCT Filed: Feb. 22, 2012
(86) PCT No.: PCT/JP2012/054207

§ 371 Date: Sep. 17, 2013

(30) Foreign Application Priority Data
Jul. 4, 2011 (JP) 2011-148084

(51) Int. Cl. B41J 25/00

(52) U.S. Cl. CPC B41J 25/001
USPC 347/37

(57) ABSTRACT

In an inkjet printer having a structure in which a plurality of mounting structural portions for coupling a carriage to a Y-rail in a movable manner are provided on one side of the carriage, in order to improve image quality by preventing deterioration in landing accuracy of ink along with high-speed movement of the carriage, a weight is mounted on another side of the carriage so as to suppress vibration of the carriage and deterioration in landing accuracy of ink along with the vibration of the carriage. Thus, the image quality is improved.

### TECHNICAL FIELD

The present invention relates to an inkjet printer for recording an image by ejecting ink.

### BACKGROUND ART

In order to meet a demand for higher speed and higher image quality of inkjet printers, there is a growing need to increase the speed and enhance the accuracy of a landing position of ink to be ejected onto a recording medium. When the apparatus is operated at high speed, vibration of a carriage, which is at a level ignorable in a conventional apparatus, affects the accuracy of the landing position of ink. Therefore, the accuracy of straightness of a Y-rail for guiding the carriage and the rigidity of a coupling portion between the carriage and the Y-rail have been enhanced for improvement to securely move the carriage along the straight Y-rail.

Further, for example, JP2009-23173A describes an inkjet printer having a configuration for suppressing movement such as vibration of the carriage instead of enhancing the accuracy of components as described above. In the configuration of this technology, weights are mounted on the carriage so as to be adjacent to both sides of a recording head, and the mass of the recording head is substantially increased to suppress the vibration of the carriage. As a result, the movement such as the vibration of the carriage can be suppressed, and the deterioration in accuracy of the landing position of ink due to the vibration can be reduced. Thus, decrease in print quality along with the behavior of the carriage is prevented.

### CITATION LIST

### Patent Literature

Patent Literature 1: JP 2009-23173 A

### SUMMARY OF INVENTION

### Technical Problems

In the conventional technology, the weights are mounted on a recording head case so as to be adjacent to the recording head in a scanning direction of the recording head, and the recording head case is mounted on the carriage. Each of the weights has a length substantially equal to the length of the recording head in a conveyance direction of the recording medium. Therefore, the carriage merely becomes heavier.

Further, the weights are not directly fixed to the carriage but placed on the recording head case on which the recording head is mounted, and the recording head case is fixed to the carriage. Therefore, the recording head case becomes extremely heavy due to the weights and the recording head. Such a heavy component is fixed to the carriage, and hence chattering may also occur in a connection portion therebetween along with the movement of the carriage, with the result that the image quality may be decreased. Further, in a case of carrying out work of, for example, adjusting and replacing the recording head and the weights, the recording head case needs to be removed for facilitating the work.

Further, in the conventional technology, the vibration of the carriage cannot be suppressed effectively. The weights are placed over a range from a proximal side to a distal side of a guide member for the carriage. That is, the weights are arranged in parallel to a longitudinal direction of the recording head, that is, a nozzle array, and further in the front and rear of the carriage in a traveling direction thereof. That is, the carriage becomes heavier by mounting the weights, but a part of the weights is located near the guide member, and hence the effect of the weights is reduced in a rotating direction of the carriage assuming that the guide member for the carriage is a rotational axis, that is, in a direction in which the recording head moves closer to and away from the recording medium.

Therefore, to suppress the vibration of the carriage, it may be necessary to use a still heavier weight, which raises a problem when increasing the speed of the carriage. To move the carriage at high speed, drive means such as a motor is upsized undesirably.

### Solution to Problems

The present invention provides an inkjet printer capable of effectively suppressing vibration of a carriage and deterioration in landing accuracy of ink due to movement other than movement in in a scanning direction of the carriage, and further capable of improving print quality by enhancing the landing accuracy of ink, and downsizing the inkjet printer.

Therefore, the present invention provides an inkjet printer, including: a plurality of print heads for ejecting ink onto a recording medium; a carriage including a carriage base, to which the plurality of print heads are fixed so as to be opposed to the recording medium; a rail arranged along a direction crossing a conveyance direction of the recording medium; and a plurality of mounting structural portions for coupling the carriage to the rail in a movable manner, each of the plurality of mounting structural portions including a plurality of bearings and being arranged on one side of the carriage in a direction orthogonal to the rail. The inkjet printer is configured to record an image by ejecting the ink onto the recording medium from the plurality of print heads while moving the carriage along the rail, the carriage being coupled to the rail in the movable manner by the plurality of mounting structural portions. The inkjet printer further includes a weight fixed to the carriage base at a position on another side of the carriage, which is opposed to the one side across the plurality of print heads.

### Advantageous Effects of Invention

According to the present invention, it is possible to provide the inkjet printer capable of suppressing the vibration of the carriage that moves at high speed, enhancing the landing accuracy of ink, improving the print quality, and downsizing the inkjet printer.

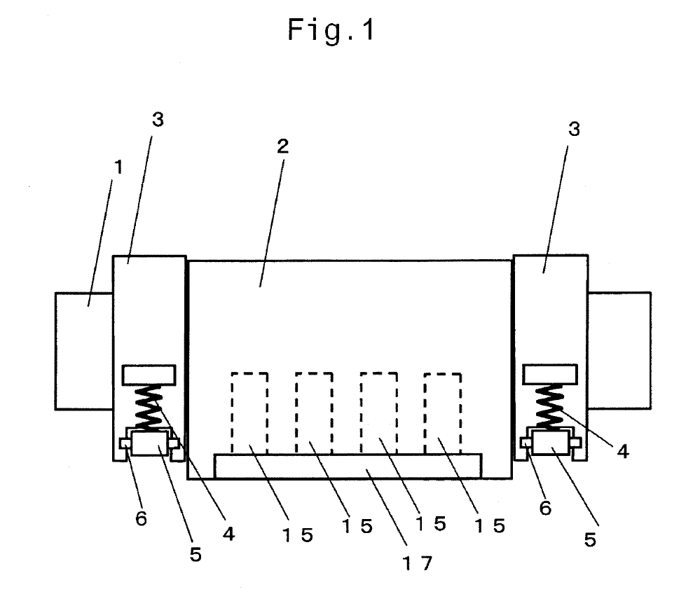

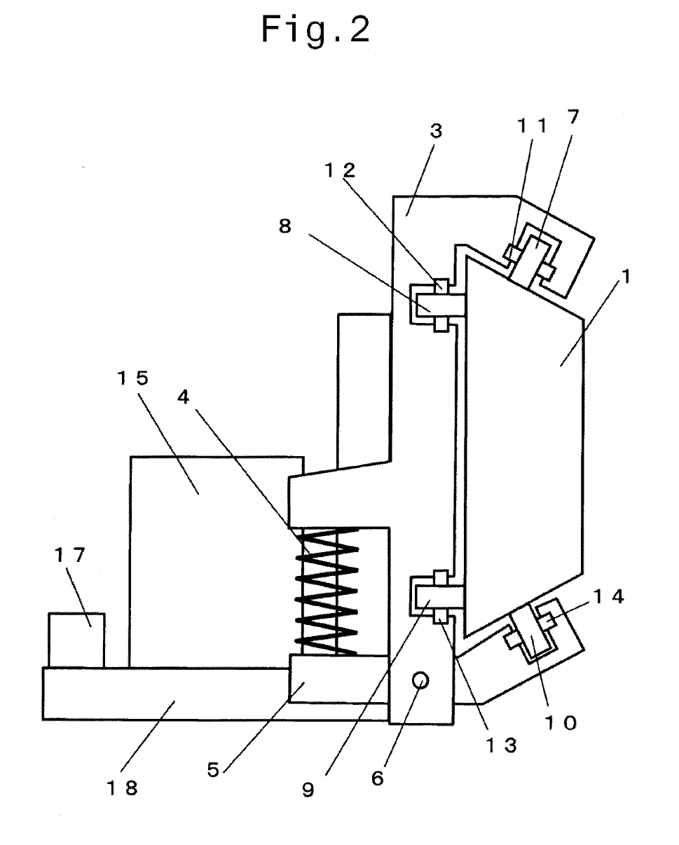

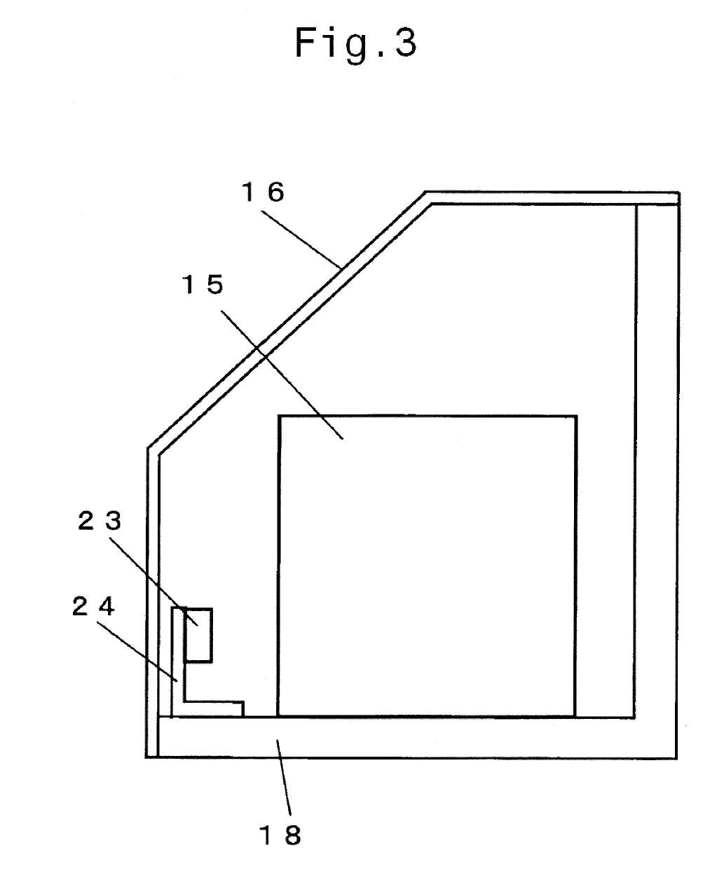

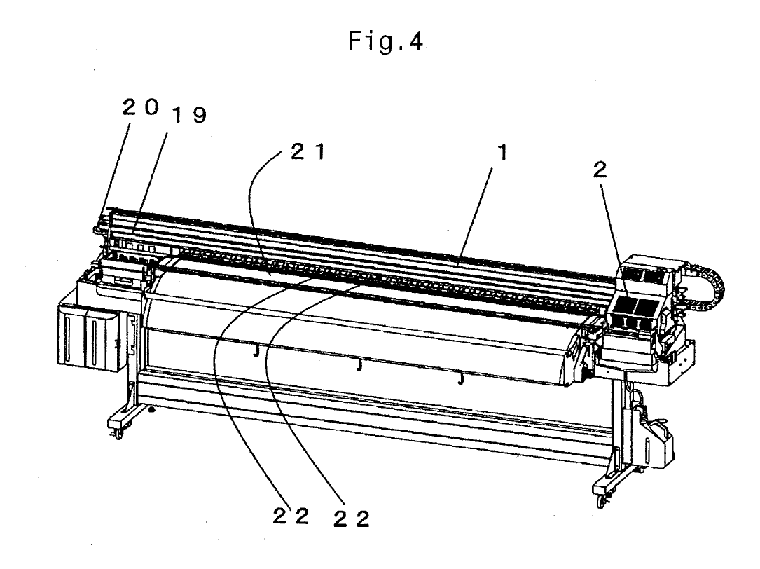

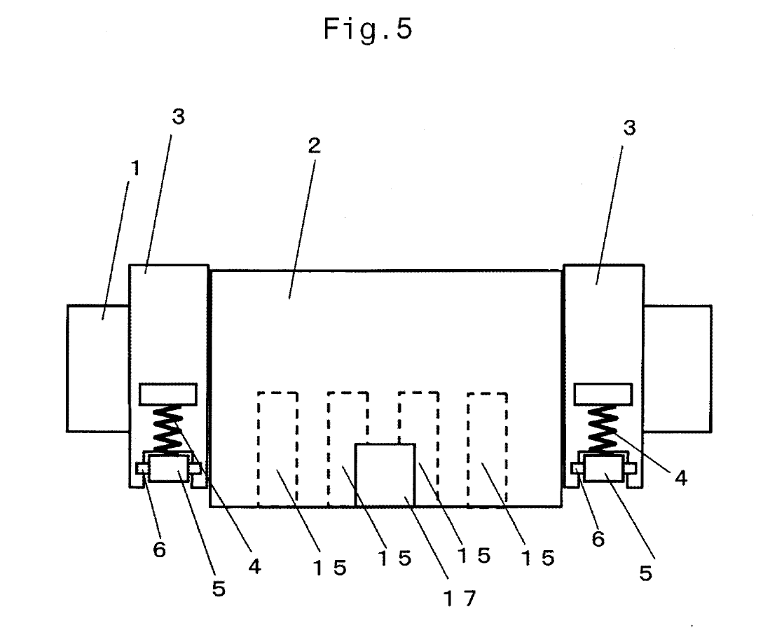

### BRIEF DESCRIPTION OF DRAWINGS

[FIG. 1] An explanatory view illustrating a configuration of a carriage.

[FIG. 2] An explanatory view illustrating a state in which the carriage is mounted on a Y-rail.

[FIG. 3] An explanatory view illustrating an example of the configuration of the carriage.

[FIG. 4] A view illustrating an example of an inkjet printer.

[FIG. 5] An explanatory view illustrating another example of arrangement of a weight.

### DESCRIPTION OF EMBODIMENT

### Overview of Embodiment

An overview of an embodiment of the present invention is described. In an inkjet printer, print heads for ejecting ink are mounted on a carriage. This carriage is configured to move in a reciprocating manner along a Y-rail, and the print heads are configured to eject ink to desired positions, to thereby form an image. The carriage is held on the Y-rail by a plurality of mounting structural portions. For example, one of the mounting structural portions is fixed to the Y-rail through an intermediation of four bearings. Mounting positions of three of the bearings are fixed relative to the Y-rail, and a mounting position of the one remaining bearing is movable relative to the Y-rail. The three fixed bearings are arranged in direct contact with the Y-rail in conformity to a shape of the Y-rail. The one remaining bearing is rotatably arranged on a pressurizing arm, and the pressurizing arm is rotatably supported on the mounting structural portion by a pressurizing arm shaft. On the pressurizing arm, the bearing is arranged on one side and a pressurizing spring is arranged on another side across the pressurizing arm shaft. Due to a force of the spring, the bearing is pressed against the Y-rail. The pressurizing spring generates a sufficiently large force to prevent chattering even when the carriage is mounted on the Y-rail, and holds the carriage so as not to bounce even when the carriage moves in a scanning manner along the Y-rail. For example, in a case where the carriage is suspended from the Y-rail at two front and rear positions of the carriage in a scanning direction thereof, when the Y-rail is distorted, any one of the bearings on the front or rear side may be separated from the Y-rail. In this case, vibration occurs in the carriage. When this vibration is suppressed, the image quality can be improved.

On the carriage, a plurality of ink ejection surfaces of the print heads are arranged so as to be opposed to a recording medium. Further, the ejection surfaces are arranged in parallel so that a conveyance direction of the recording medium matches with a longitudinal direction of the ejection surfaces. For example, print heads corresponding to four colors of yellow, cyan, magenta, and black are mounted on the carriage. A larger number of print heads may be mounted thereon. Further, a weight is provided to a distal end portion of the carriage, that is, on a side opposed to the Y-rail side across a recording head. This weight is arranged so that a gravity center position of the carriage in a moving direction thereof overlaps with an arrangement position of the weight. For example, when the gravity center position of the carriage is located at a center of the carriage, the weight is arranged so as to overlap with the center portion of the carriage in the moving direction thereof. Further, a more significant effect is obtained when the weight is placed at a position away from the Y-rail. The weight may have a bar shape. When the weight has a bar shape, the bar-shaped weight is arranged so that a longitudinal direction thereof is parallel to the conveyance direction, and is further fixed to a bottom portion of the carriage. With this configuration, when the carriage moves in a direction other than the scanning direction of the carriage, it is necessary to generate greater kinetic energy than in the case where the weight is not provided, and thus the vibration can be suppressed. Further, when the weight has a block or bar shape such as a cube, a rectangular solid, and a column, it is preferred that the gravity center of the weight be arranged equidistant from the two mounting structural portions so as to maintain a balance between the advance and the retreat of the reciprocating scanning movement.

### Details of Embodiment

The embodiment of the present invention is described below with reference to the drawings. FIG. 1 is an explanatory view illustrating a configuration of the carriage. FIG. 2 is an explanatory view illustrating a state in which the carriage is mounted on the Y-rail. FIG. 3 is an explanatory view illustrating an example of the configuration of the carriage.

A Y-rail 1 has a length substantially equal to the entire width of the inkjet printer, and functions as a guide at the time of scanning movement of a carriage 2. FIG. 1 illustrates the Y-rail 1 that is partially enlarged with respect to the entire length thereof. One or more print heads 15 are mounted on the carriage 2, and are configured to eject ink at appropriate timings based on image data, to thereby form an image. The carriage 2 is mounted on a belt 19, and when the belt 19 is driven, the carriage 2 moves together with the belt 19.

The carriage 2 is mounted on the Y-rail 1 through an intermediation of mounting structural portions 3. The mounting structural portions 3 are arranged at both front and rear end portions of the carriage 2 in a scanning direction thereof. In this case, the respective mounting structural portions 3 have the same configuration, and hence one of the mounting structural portions 3 is described. The mounting structural portion 3 includes a bearing “a” 7, a bearing “b” 8, a bearing “c” 9, and a bearing “d” 10, which allow the mounting structural portion 3 to be mounted on the Y-rail 1 so as to be movable in a scanning manner without falling off the Y-rail 1. The bearing “a” 7, the bearing “b” 8, and the bearing “c” 9 of the mounting structural portion 3 are fixed to the mounting structural portion 3 so as to avoid shifting their mounting positions and to be rotatable about a bearing spindle “a” 11, a bearing spindle “b” 12, and a bearing spindle “c” 13, respectively. However, only the bearing “d” 10 is mounted through an intermediation of a movable pressurizing arm 5. The bearing “a” 7 and the bearing “b” 8 are provided so as to sandwich a top portion of the Y-rail 1. The bearing “c” 9 and the bearing “d” 10 are provided so as to sandwich a bottom portion of the Y-rail 1. The four bearings apply forces in a perpendicular direction and a horizontal direction of the Y-rail 1.

A pressurizing arm shaft 6 is provided substantially at a center of the pressurizing arm 5, and the pressurizing arm 5 is pivotably supported by the pressurizing arm shaft 6. The bearing “d” 10 is mounted on the pressurizing arm 5 so as to be rotatable about a bearing spindle “d” 14. Further, a pressurizing spring 4 is arranged opposite to a mounting position of the bearing “d” 10 across the pressurizing arm shaft 6, and is configured to bias the bearing “d” 10 into contact with the Y-rail 1. As a result, the bearing “d” 10 is rotatable while being constantly in contact with the Y-rail 1.

The carriage 2 projects on a downstream side of the Y-rail 1 in a conveyance direction of the recording medium, and is provided so that a part of the projecting portion is opposed to a platen 21. The carriage 2 includes a cover 16 for covering built-in components such as the print heads 15. The carriage 2 further includes a carriage base 18 fixed to the mounting structural portion 3. The print heads 15 are arranged on this carriage base 18. The print heads 15 have nozzle surfaces opposed to the platen 21, and are configured to eject ink to the recording medium supported by the platen 21. A weight portion 17 includes a weight 23 and a fixing bracket 24. The fixing bracket 24 is fixed to the carriage base 18, and the weight 23 is fixed to the fixing bracket 24. The weight 23 is made of a bar-shaped metal at a length substantially equal to the entire width of the carriage base 18 in the scanning direction, and is arranged so that a longitudinal direction of the weight 23 is parallel to the scanning direction of the carriage. Further, the weight 23 is provided to a distal end portion of the carriage 2, that is, a downstream end portion in the conveyance direction of the recording medium.

The carriage 2 is firmly in contact with the Y-rail 1 and moved along the Y-rail 1 by the mounting structural portion 3, but a torsion and a curve of the Y-rail 1 cause chattering of the mounting structural portion 3, small movement in a direction other than the scanning direction, or vibration due to the small movement. However, with the configuration as described above, the vibration of the carriage 2 can be suppressed effectively by the weight 23. That is, the small movement of the carriage 2 is suppressed by the weight 23. Along with the movement of the carriage 2, great kinetic energy corresponding to the mass of the weight 23 is generated along the direction of the movement. Therefore, to cause movement against the kinetic energy, it is necessary to generate greater kinetic energy than in the case where the weight is not provided. Further, the weight 23 is arranged away from the mounting structural portion 3 to the extent possible. For example, the weight 23 is arranged so as to secure a space for arranging the print heads 15 between the weight 23 and the Y-rail 1. Therefore, to cause movement of the carriage 2 in a rotating direction thereof assuming that the scanning direction of the mounting structural portion 3 is a rotational axis, it is necessary to generate greater kinetic energy due to the weight 23. Such a configuration is preferred in a case where the mounting structural portion 3 is provided only on one side of the carriage 2 and connected to the Y-rail 1.

Further, the weight 23 is arranged at the position away from the Y-rail 1, and in this case, the weight 23 is fixed to the carriage base 18, to which the print heads 15 are fixed. Thus, it is possible to more effectively suppress the movement other than the movement in the scanning direction, such as vibration that deteriorates the landing accuracy of ink droplets ejected from the print heads 15. For example, the weight 23 may be arranged on the cover 16, but this arrangement is not preferred because certain connection means is necessary for the cover 16 and the carriage base 18 and vibration or the like may occur due to chattering caused by, for example, looseness in a connection portion of the connection means. In a case where the weights are mounted directly on the print heads 15, this direct mounting is not preferred because the plurality of print heads 15 are mounted on the carriage 2 and thus the weights may affect each other when the carriage 2 moves. Therefore, it is preferred that the weight 23 be arranged on the carriage base 18 at a position opposite to the Y-rail 1 across the print heads 15 so that the longitudinal direction of the weight 23 is parallel to the scanning direction of the carriage 2. In this case, it is preferred that the length of the weight 23 be equal to or larger than a distance between the print heads 15 arranged at both ends of the carriage 2 in the scanning direction thereof.

Further, it is preferred that the carriage 2 be downsized and lightened to the extent possible so that a drive motor can be downsized. In view of this, the weight 23 is fixed to the carriage base 18 with the fixing bracket 24, and a space is provided between the weight 23 and the carriage base 18 so that wiring connected to the print heads 15 can be arranged in this space. With this configuration, the wiring is easily operated when the weight 23 is removed from the fixing bracket 24, and the wiring can also be protected by the weight 23. The carriage 2 can be downsized into an organized interior. The wiring is a signal line such as a control line extending from a circuit in a main body of the inkjet printer.

FIG. 5 is an explanatory view illustrating another example of the arrangement of the weight. The weight portion 17 is a columnar metal block arranged substantially at a center of the carriage 2 in a moving direction thereof, that is, at a gravity center position of the carriage 2 in the moving direction thereof. The weight portion 17 is arranged so as to overlap with the gravity center position of the carriage 2 in the moving direction thereof. Further, the weight portion 17 is arranged on the carriage 2 on a side opposed to the Y-rail 1. It is preferred that the gravity center of the carriage 2 in the moving direction thereof correspond to the center of the carriage 2. The gravity center of the weight portion 17 is arranged equidistant from the mounting structural portions 3 on the right and left of the carriage 2. This is because the gravity center position corresponds to the center of the carriage 2.

Further, laminated sheet metals may be used for the weight. To avoid interference with other components, the weight may have a complex shape. The laminate structure obtained by combining sheet metals having different shapes can lead to further cost reduction than in a case of forming the weight from a single piece of metal. Further, a structure for mounting a clamp to be used for fixing the wiring in the vicinity of the weight can be formed easily on the weight.

FIG. 4 illustrates an example of the inkjet printer. The Y-rail 1 is provided substantially over the entire width of the inkjet printer. An ink jet head is mounted inside the carriage 2. The belt 19 is looped around a pulley 20, and the carriage 2 is connected to the belt 19. A pulley paired with the pulley 20 is located behind the carriage 2 in FIG. 4, and is therefore omitted in FIG. 4. The belt 19 is configured to rotate while switching a rotating direction thereof. In synchronization with the rotation of the belt 19, the carriage 2 connected to the belt 19 moves in a reciprocating manner along the Y-rail 1. The platen 21 is configured to support the recording medium conveyed by conveyance rollers 22. A plurality of conveyance rollers 22 are arranged along the platen 21. For example, the recording medium is a plastic film or paper. The carriage 2 and the platen 21 are arranged so as to secure a distance of several millimeters between the carriage 2 and the recording medium supported by the platen 21. The print heads 15 mounted on the carriage 2 are configured to eject ink onto the recording medium, to thereby record an image. The moving direction of the carriage 2, that is, the scanning direction of the carriage 2 corresponds to a direction crossing the conveyance direction of the recording medium, and in this example, corresponds to a direction orthogonal to the conveyance direction of the recording medium. The recording medium is intermittently driven in the conveyance direction, and the recording is carried out when the recording medium is stopped. Thus, the conveyance and the recording are carried out alternately.

The recording medium having the image recorded thereon is conveyed from a rear side to a front side of the inkjet printer in FIG. 4. That is, the recording medium is output through a lower side of the Y-rail 1, the carriage 2, and the like. Therefore, the Y-rail 1 and the mounting structural portions 3 of the carriage 2 are not located on the front side of the inkjet printer, and hence the user can easily open the cover 16 of the carriage 2 to carry out, for example, positional adjustment work for the print heads 15 and the weight portion 17. Further, the weight portion 17 and the print heads 15 are arranged on the carriage 2 in an order from the front side, and hence work of mounting the weight portion 17 and the like can be carried out easily. As described above, maintenance and assembly can be carried out easily as well.

### INDUSTRIAL APPLICABILITY

The present invention is applicable to an inkjet printer.

### REFERENCE SIGNS LIST

1 Y-rail

2 carriage

3 mounting structural portion

4 pressurizing spring

5 pressurizing arm

6 pressurizing arm shaft

7 bearing “a”

8 bearing “b”

9 bearing “c”

10 bearing “d”

11 bearing “a” spindle

12 bearing “b” spindle

13 bearing “c” spindle

14 bearing “d” spindle

15 print head

16 cover

17 weight portion

18 carriage base

19 belt

20 pulley

21 platen

22 conveyance roller

23 weight

24 fixing bracket

1. An inkjet printer, comprising:
a plurality of print heads for ejecting ink onto a recording medium;
a carriage comprising a carriage base, to which the plurality of print heads are fixed so as to be opposed to the recording medium;
a rail arranged along a direction crossing a conveyance direction of the recording medium; and
a plurality of mounting structural portions for coupling the carriage to the rail in a movable manner, each of the plurality of mounting structural portions comprising a plurality of bearings and being arranged on one side of the carriage in a direction orthogonal to the rail,
the inkjet printer being configured to record an image by ejecting the ink onto the recording medium from the plurality of print heads while moving the carriage along the rail, the carriage being coupled to the rail in the movable manner by the plurality of mounting structural portions,
the inkjet printer further comprising a weight fixed to the carriage base at a position on another side of the carriage, which is opposed to the one side across the plurality of print heads.

2. An inkjet printer according to claim 1, wherein the weight is arranged at a position including a gravity center position of the carriage in a direction parallel to the rail.

3. An inkjet printer according to claim 2, further comprising a spring for biasing at least one of the plurality of bearings toward the rail.

4. An inkjet printer according to claim 3, wherein a gravity center of the weight is located equidistant from the plurality of mounting structural portions.

5. An inkjet printer according to claim 4, wherein the weight is fixed to the carriage through an intermediation of a fixing bracket.

6. An inkjet printer according to claim 5, further comprising wiring arranged between the weight and the carriage, the wiring being connected to the plurality of print heads.

7. An inkjet printer according to claim 4, wherein the weight has a bar shape, and is arranged so that a longitudinal direction of the weight is parallel to the rail.

8. An inkjet printer according to claim 7, wherein a length of the weight in the longitudinal direction is larger than a distance between the plurality of print heads arranged at both ends of the carriage.

9. (canceled)
